(19) United States
(12) Patent Application Publication
(10) Pub. No.: US 2018/0160628 A1
(43) Pub. Date: Jun. 14, 2018

(54) Coilable Aerodynamic Leaf Bagging Device Intended for Use with Power blower

(71) Applicant: Shirley Carter Harlan, Fort Worth, TX (US)

(72) Inventor: Shirley Carter Harlan, Fort Worth, TX (US)

(21) Appl. No.: 15/377,123

(22) Filed: Dec. 13, 2016

(51) Int. Cl. A01G 1/12

(52) U.S. Cl. CPC A01G 1/125

(57) ABSTRACT

A coilable leaf bagging device generally oval/egg shaped in configuration, with rear attachment of disposable specifically designed perforated receptacle. It is intended for use in bagging leaves, utilizing the aerodynamics of a power operated leaf/lawn debris power blower. It is unique in it's design facilitating the combined collection and subsequent bagging of leaves/debris with limited or elimination of physical labor which incorporates a racking or lifting action. Device is comprised of 6 membranes, and 3 flexible loop members having memory, within sleeves to form a plurality of concentric loop rings and layers of aerodynamically constructed membrane to substantially reduce the size of the structure which is able to be supported on a penetrable firm surface.

### BACKGROUND OF THE INVENTION

### 1. Field of the Invention

This invention relates to the collection and subsequent bagging of lawn debris, leaves or other particles of collection appropriately selected in conjunction with a powered blower apparatus by the attachment of a specially designed disposable aerodynamic receptacle utilizing a coiling device having a multiple of panels that can be coiled and flattened to reduce the overall size of the device.

### 2. Description of the Art and Known Prior Art

In depth search by the inventor included over 1200 filed patent applications/patents, reveals no prior art that in any way duplicates or resembles this invention. The main consideration is use of the power blower in conjunction with this device as opposed to other devices that may SEEM similar. Other devices thus far have not incorporated the power blower to transfer debris or other articles from the existing location to the internal location of a refuge bag (receptacle). Any other devices simply place debris in or onto that device but raking and or lifting are then necessitated to complete the process transferring the debris into a bag or receptacle.

### Specific Problems with Similar Devices

There has long been a need for an item that reduces the bodily stress and damage of the user in the process of actually bagging leaves during the lawn care initiative. Several attempts have been tried to remedy these problems without success. This invention simply solves the problem. Previous attempts at reducing the work effort and physical stress include but are not limited to the following art designs;

1) Large flat sheets incorporating the use of mere handles at the four corners to facilitate the gathering of the leaves. It does not eliminate the raking or lifting actions.

2) Large flat devices with a central flat piece utilizing attached, hinged “wings” with handles are used to rake debris upon and then lift into receptacle.

3) Some may use a device similar to the device aforementioned, by placing the device within the opening of a bag which lies flat on the ground, requiring raking debris into the opening created by the device with the wing tips pointing upward. A power blower cannot be used due to the aerodynamics of the ventless bag and lack of side structures with which to direct leaves into a path of the bag opening on the ground.

4) Free standing devices, created of wire in the shape of a typical garbage receptacle, have been used. The only advantage of this type device is the elimination of the airspace which is typically problematic with the use of standard garbage receptacles. Raking and lifting are still required.

5) There are many types of “Scoopers and Grabbers” available. These are merely devices created to hold and manually pick up debris in a “tong” like fashion. Raking is still required and placing debris into the container still required.

The popularity in the use of designs that coil and reduce the size of the object, is increasing. These types of devices have a plurality of panels and can be turned and coiled to reduce the overall size of the units substantially for ease and convenience of storage and use.

### BRIEF SUMMARY OF THE INVENTION

The Leaf Bagger is a cost-effective device which sits passively between two existing technologies, a “disposable plastic lawn waste bag” and an ordinary “leaf blower”, utilizing a simple aerodynamic single surface boomerang shape forming a concave structure, allowing a more effortless, standing position to that of most typical processes for bagging leaves or other debris which may be found on ground or other soft surfaces which might apply. It provides a lightweight, less than 11 oz, solution to any previous devices, with working surfaces being constructed of 100% mesh fabric, collapsible to a 1″ flat configuration, utilizing a twist and fold design.

### Purpose and Advantages of Invention Technology

This device is most appreciated for easing or eliminating tension, strain and damage to the upper arm and back area when used as intended by reducing if not completely eliminating the position of bending over to place refuge in bags or having to utilize a raking action in conjunction with the bagging process. The operator of the blower is allowed to remain in the upright and standing position throughout the collection process up to and including the final stages of filling utilizing the specially designed disposable aerodynamic disposable receptacle, thereby reducing or eliminating additional back strain and injury. The invention is stable for the use intended when fully expanded. It provides performance, safety and convenience. As it relates to performance, this device clearly does what it says it will do in that it is designed to withstand the force created by the blower's velocity which is used in conjunction with the device and thereby funnels the particles being blown directly into the center opening where it is automatically bagged into its specially designed disposable aerodynamic receptacle ready for pickup and disposal. Safety is assumed when using, storing and handling the invention with intended use. Convenience is achieved by means of the ease of storage and retrieval processes. The devices currently available are large in size, bulky and are not intended for use with a blower. If a blower is used, the receptacle used is of a non-disposable variety and contents of the receptacle must still be then transferred by lifting an already full container upward and into the disposable plastic bag. Thus back injury, strain and greater physical fatigue resulting. Storage is facilitated by simply turning the assembly and coiling it down into a flattened configuration. Materials for manufacturing are very lightweight therefore portability is achieved.

### Best Mode

The Leaf Bagger is designed to function on most any terrain, dirt, gravel, landscaping applications such as lava rock or mulch products, and any other naturally existing or enhanced ground area into which the wicket pins can be placed without damage to the surface of application. Exclusive for use would be rocks or cement type surfaces into which the wickets would not penetrate.

### Advantages of the Leaf Bagger

Solves a problem—Reduces/eliminates back pain from bending typical bagging process
Eliminates mid process of lifting/transferring leaves from leaf collection device/non-disposable attached bag, into plastic curbside lawn bag
Eliminates the use of a rake
Appeals to the masses
All end users can purchase product whether commercial, retail or public
Saves Time
Small Storage Requirements—“Twist and Fold” concept for storage on wall in it's own bag
Low Cost for Manufacturing—$2.50-$3.00
Good Profit Margin—Yet affordable to consumer, Bagger retails at $19.99-$29.99
Ships Easily—Can easily fit 2-3,000 per skid
Inexpensive Manufacturing—No mechanical/moving parts—3 Pattern Pieces ×3 Steel Bands
No regulatory, food, safety or otherwise governmental regulatory agency restrictions
Life of Product—Construction is of mold/mildew proof light weight mesh
Simple Design—Only 3 pattern pieces and 3 steel memory bands
Residual Sales—Requires separately packaged/licensed disposable piece per use
Environmental—Product has no emissions or otherwise harmful eco effects. Eco friendly refill bags can also be made available

### BRIEF DRAWINGS DESCRIPTION

FIG. 1 is a three quarter front view perspective of the coiling device according to the embodiment of the invention shown in its usable expanded configuration;

FIG. 1A is a partial cut-away three quarter view of Section 12 of the design of FIG. 1 illustrating a frame member retained within a sleeve;

FIG. 1B is a cross section side view of Section 12 of the design of FIG. 1A illustrating a frame member retained within a sleeve;

FIG. 1C is a partial cut away three quarter view of Section 2 of the design of FIG. 1 illustrating a frame member retained within a sleeve;

FIG. 1D is a cross section side view of Section 2 of the design of FIG. 1C illustrating a frame member retained within a sleeve;

FIG. 1E is a partial cut away three quarter view of Section 16 of the design of FIG. 1 illustrating a frame member retained within a sleeve;

FIG. 1F is a cross section side view of Section 16 of the design of FIG. 1E illustrating a frame member retained within a sleeve;

FIG. 1G is a partial cut away three quarter view of Section 10 membrane retaining sleeve including Sections 5, 7 and 3 and Section 6 frame retaining sleeve Sections 7 and 29 of the design of FIG. 1;

FIG. 1H is cross section side view of Section 10 membrane retaining sleeve including Sections 5, 7 and 3 and Section 6 frame retaining sleeve Sections 7 and 29 of the design of FIG. 1;

FIG. 1I is a partial cut away three quarter view of Section 8 of the design of FIG. 1 illustrating a frame member and two panels retained within a sleeve;

FIG. 1J is a cross section side view of Section 8 of the design of FIG. 1I illustrating a frame member and two panels retained within a sleeve;

FIG. 2 is a perspective view of the frame members of the design of FIG. 1;

FIG. 2A is a perspective view of the frame member of the design of FIG. 1 Section 12;

FIG. 2B is a perspective view of the frame member of the design of FIG. 1 Section 10;

FIG. 2C is a perspective view of the frame members of the design of FIG. 1 Section 6;

FIG. 3 is a flat front side view of a coiling design according to the embodiment of the invention shown in its fully expanded open configuration;

FIG. 4 is a flat back side view of a design according to the embodiment of the invention shown in its fully expanded open configuration;

FIG. 5 is a flat right view of a coiling design according to the embodiment of the invention shown in its fully expanded open configuration;

FIG. 6 is a flat bottom view of a coiling design according to the embodiment of the invention shown in its fully expanded open configuration;

FIG. 6A is a partial cut away three quarter single illustration view of each of same Sections 13, 14, 17 and 18 of the design of FIG. 1 illustrating a membrane a two ended coiled panel and frame member retained within a sleeve;

FIG. 6B is a cross section side view of each of Sections 13, 14, 17 and 18 of the design of FIG. 1 illustrating a membrane a two ended coiled panel and frame member retained within a sleeve;

FIG. 7 is a flat left view of a coiling design according to the embodiment of the invention shown in its fully expanded open configuration;

FIG. 8 is a flat top view of a coiling design according to the embodiment of the invention shown in its fully expanded open configuration;

FIG. 9 is a side view of FIG. 1 membrane retaining sleeve 10 center assembly including panels 7 and 5 and frame retaining sleeve 6 demonstrating distal coiled edge 4 and central opening 19 into disposable unit FIG. 11 and coiling design according to the embodiment of the invention shown in its fully expanded open and functional configuration;

FIG. 10 is a front view of FIG. 1 with membrane retaining sleeve 10 and frame retaining sleeve 6 remaining in the original configuration with frame retaining sleeve 12 in the coiling storage configuration of the coiling design according to the embodiment of the invention shown in its coiled flattened configuration;

FIG. 11 is a flattened view of disposable unit separately supplied and attached non-permanently between membrane retaining sleeve 10 and frame retaining sleeve 6 illustrating a loop membrane retained within a draw sleeve closure at opening of specially designed disposable aerodynamic receptacle which ultimately accomplishes reduction of opening of disposable unit utilizing outward force on loop membrane within the sleeve and security of membrane within the sleeve to frame retaining sleeve 6 utilizing unit 9.

### DETAILED DESCRIPTION OF THE INVENTION

The following detailed description is of the best presently contemplated modes of carrying out the invention creation/construction. This description is made for the purpose of illustrating general principles of embodiments of the invention, and not to be taken in a limiting sense. The scope of the invention is best defined by the appended claims.

All panels and inventions' relative components can be adjusted in size and configuration to assume larger or smaller configuration with appropriate modifications in relative size of inventions other components in order to modify its utility and applications.

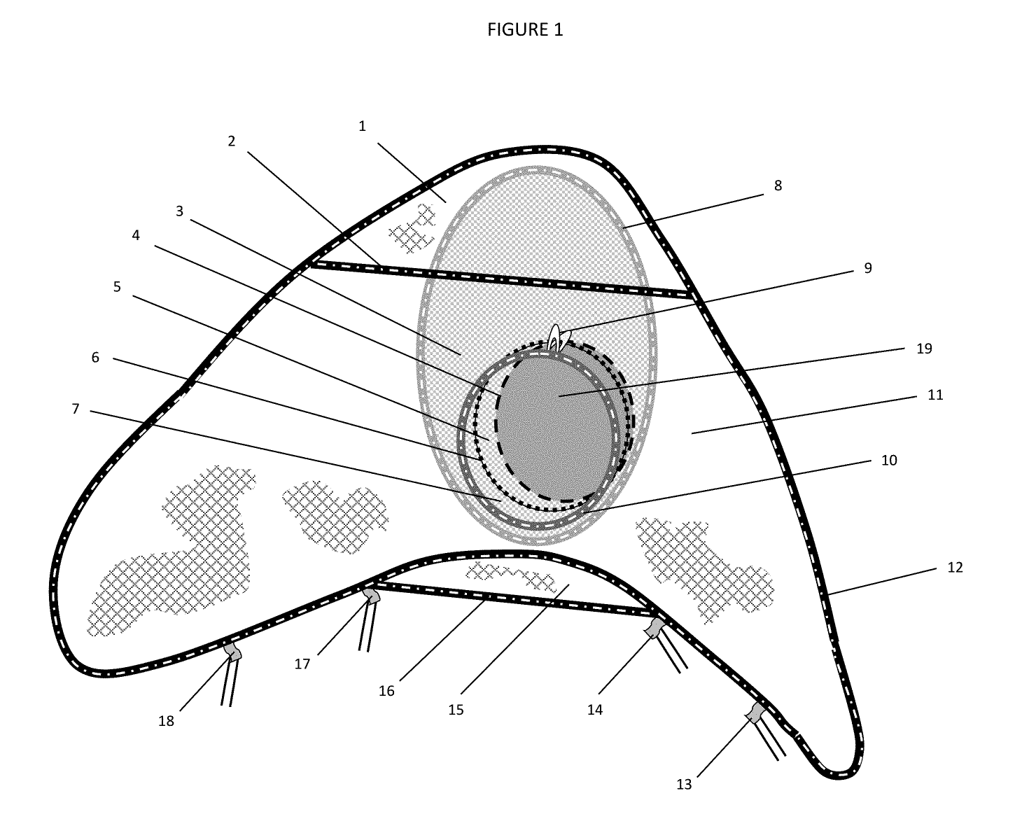

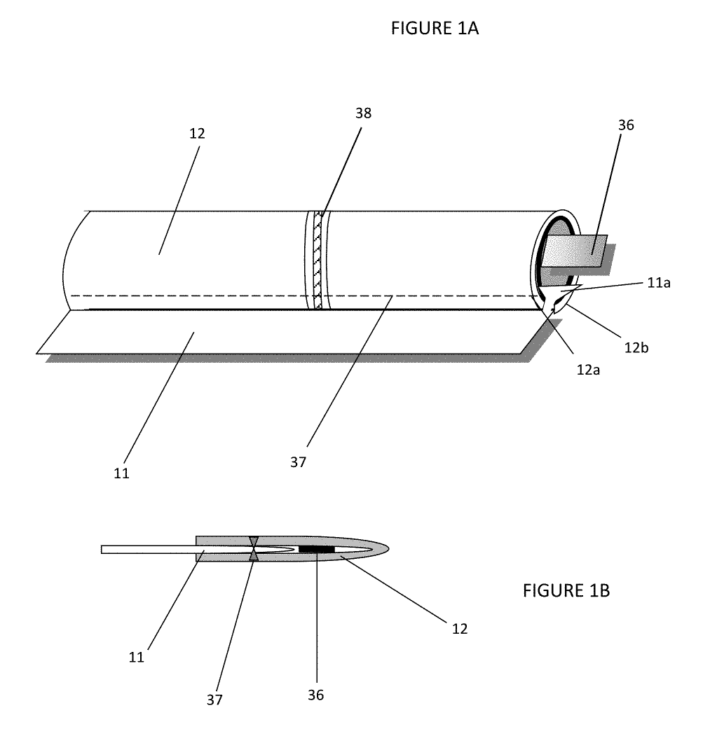

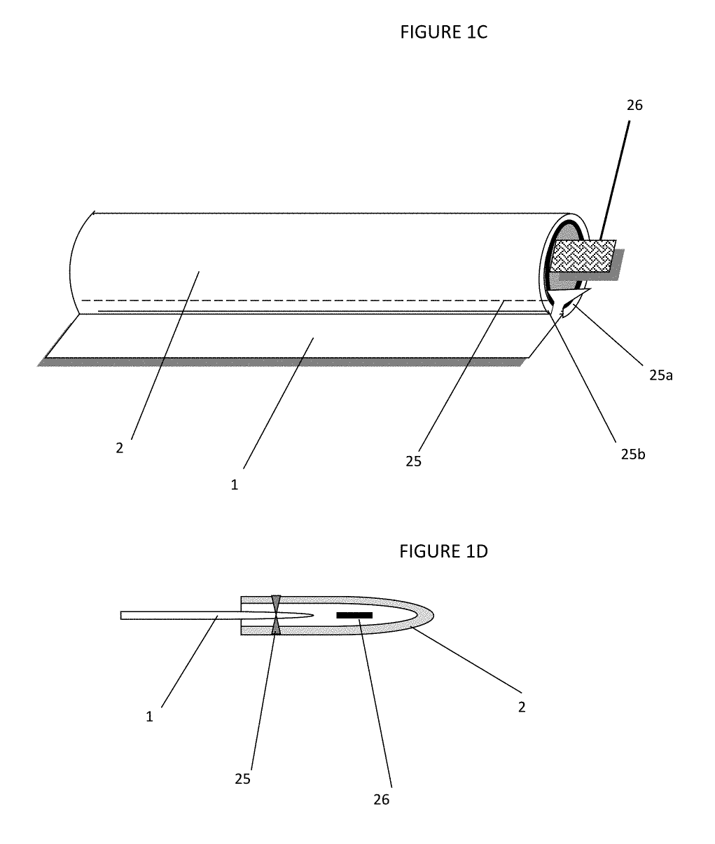

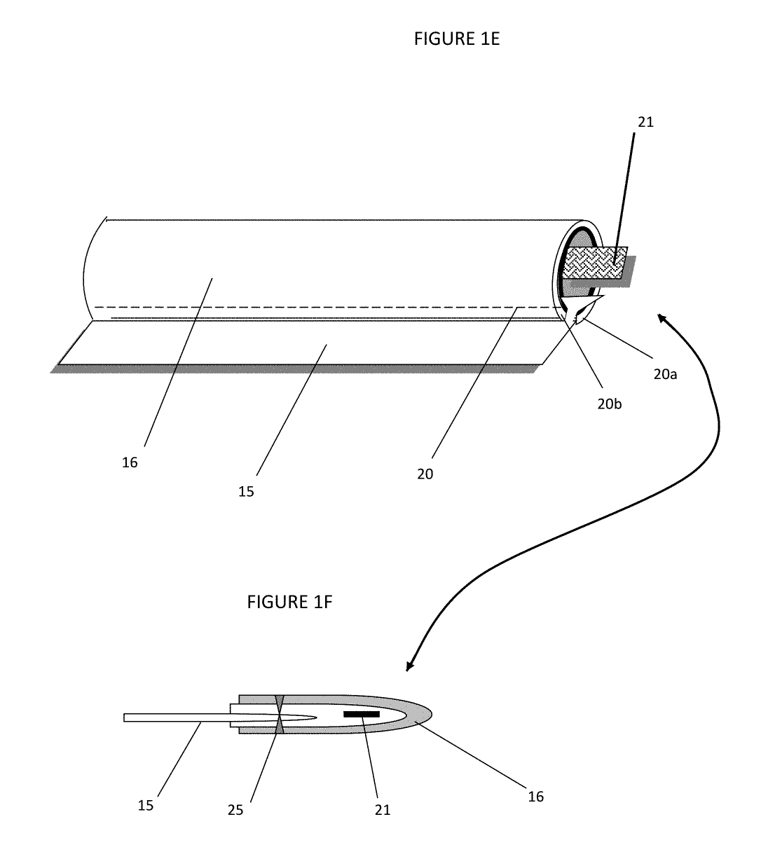

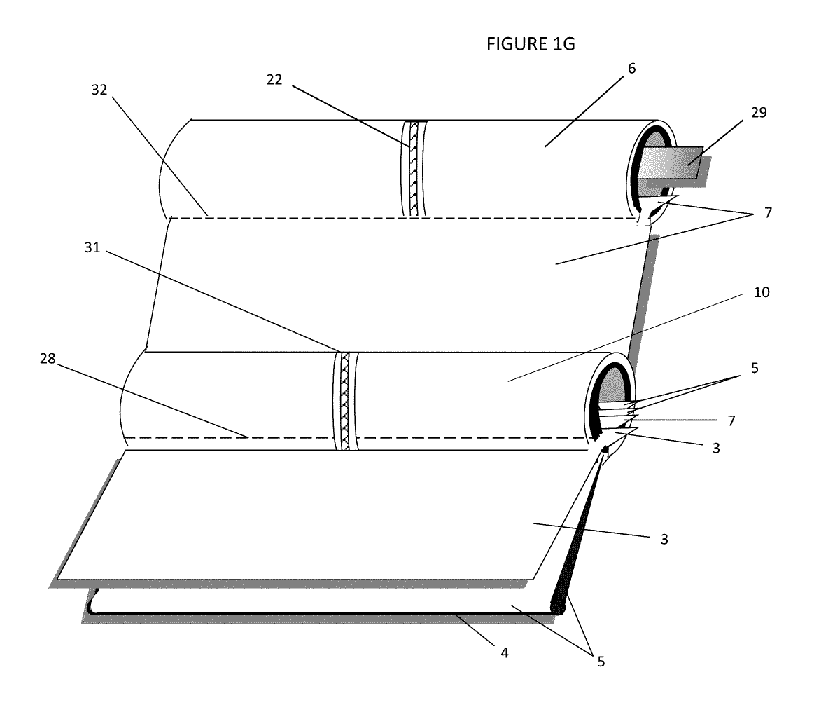

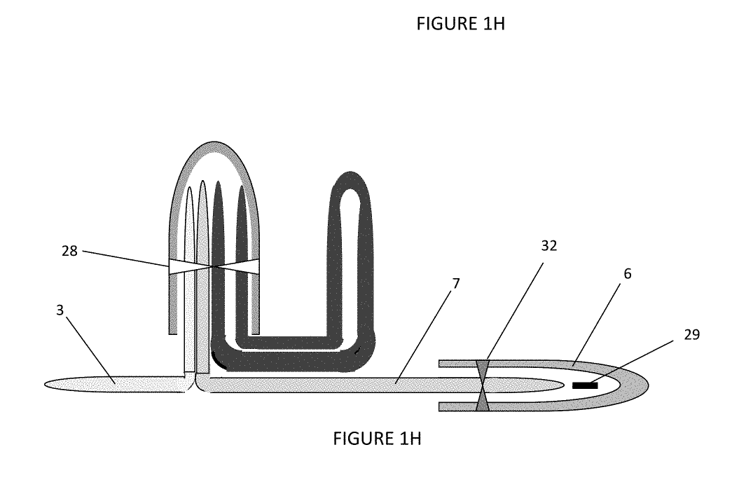

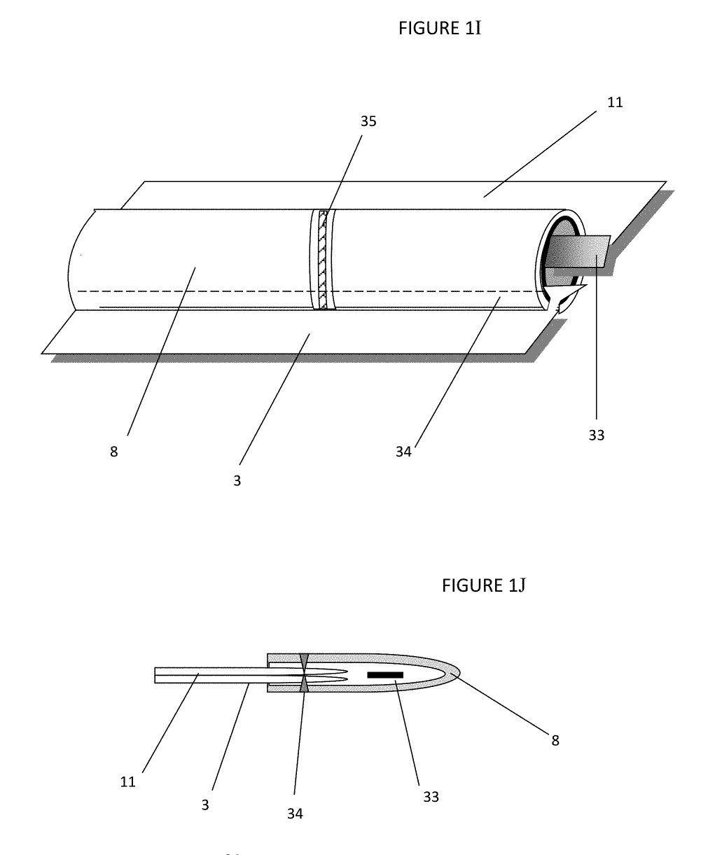

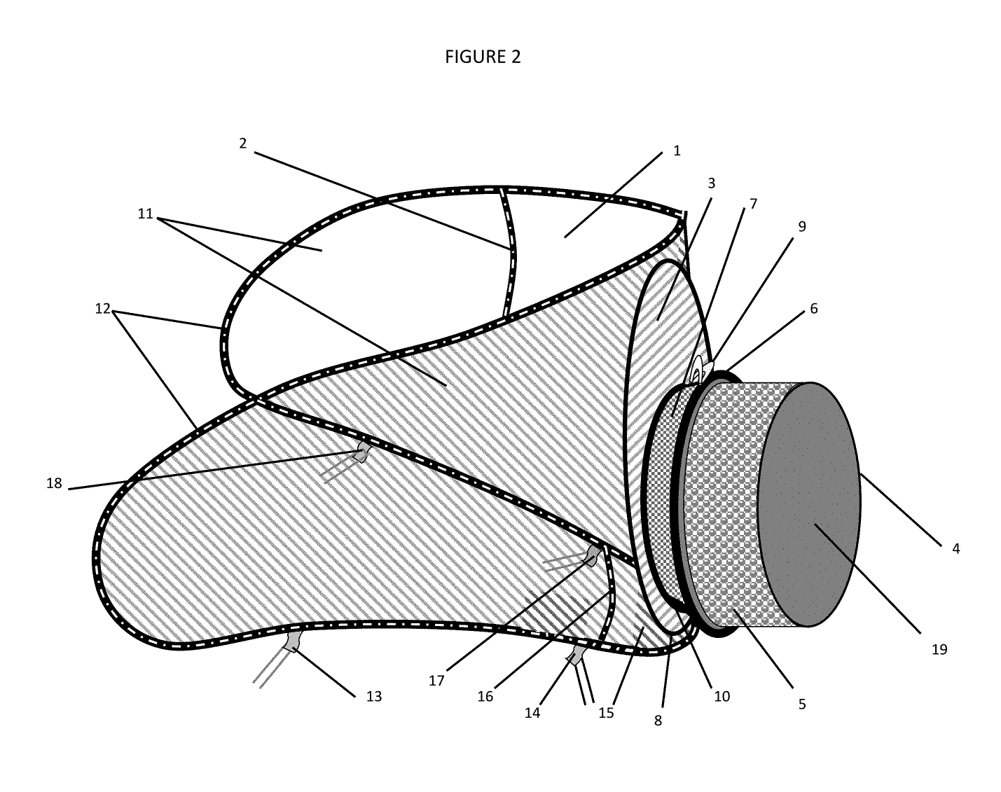

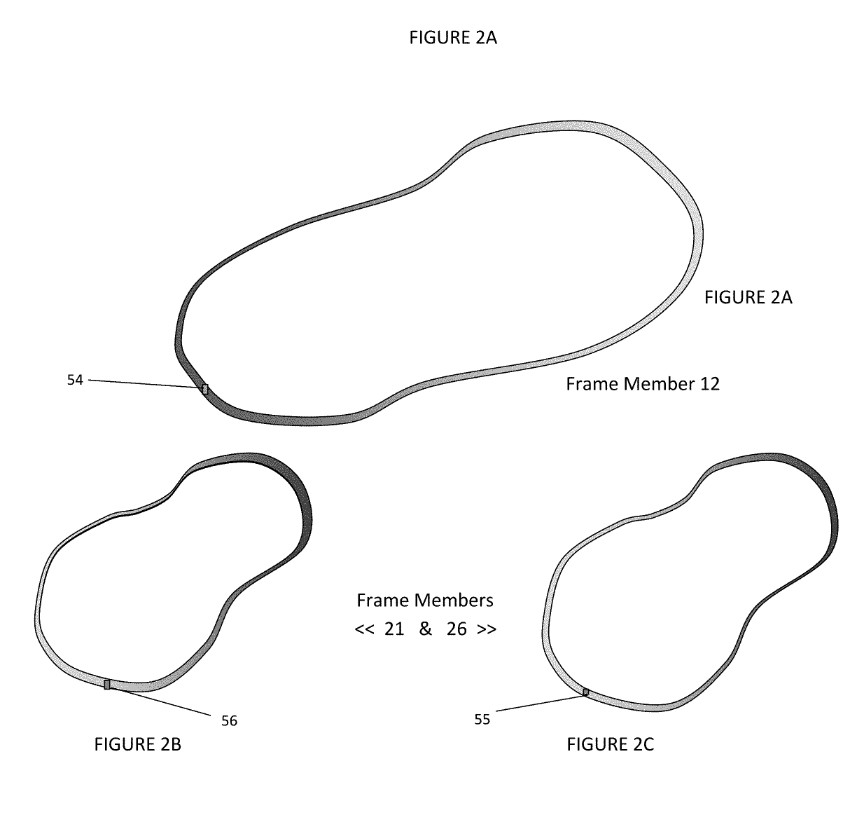

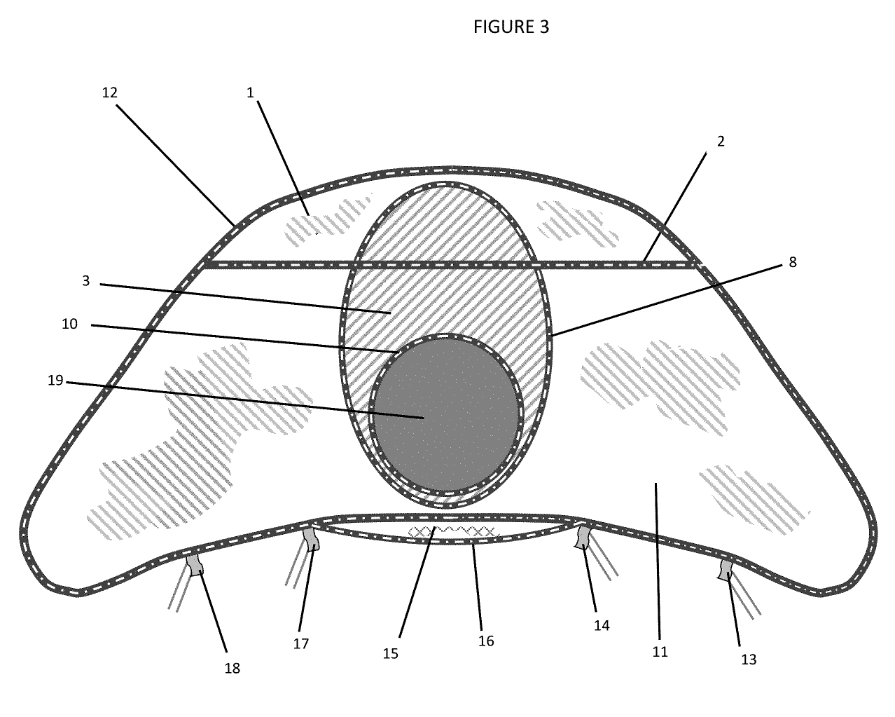

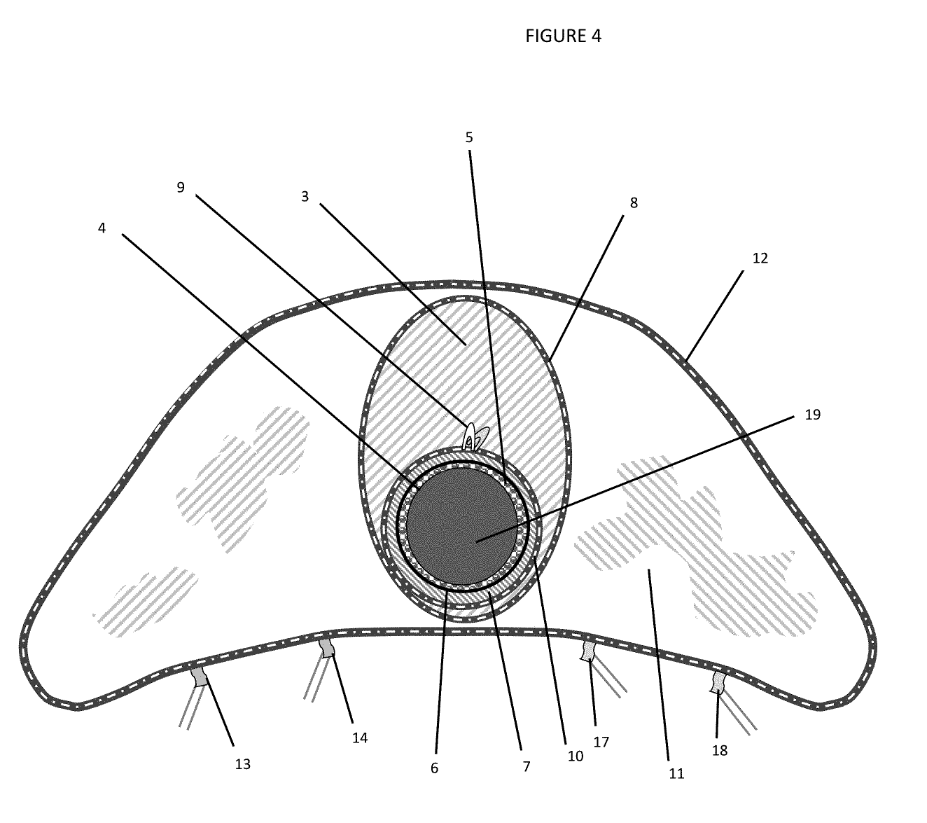

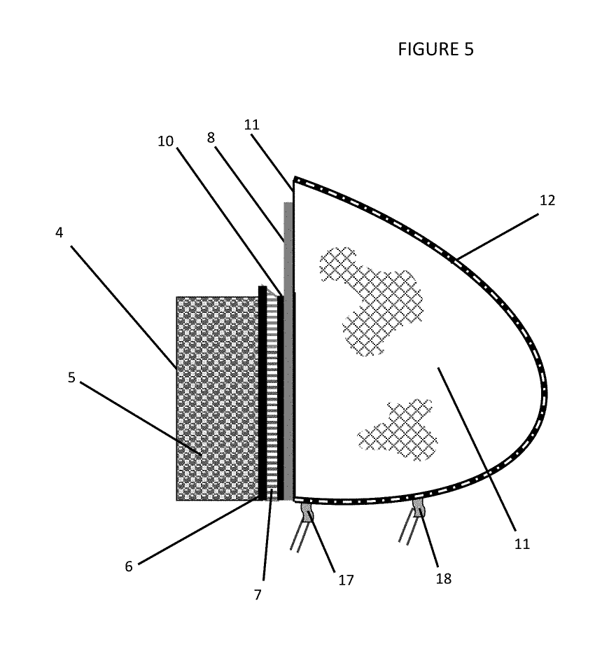

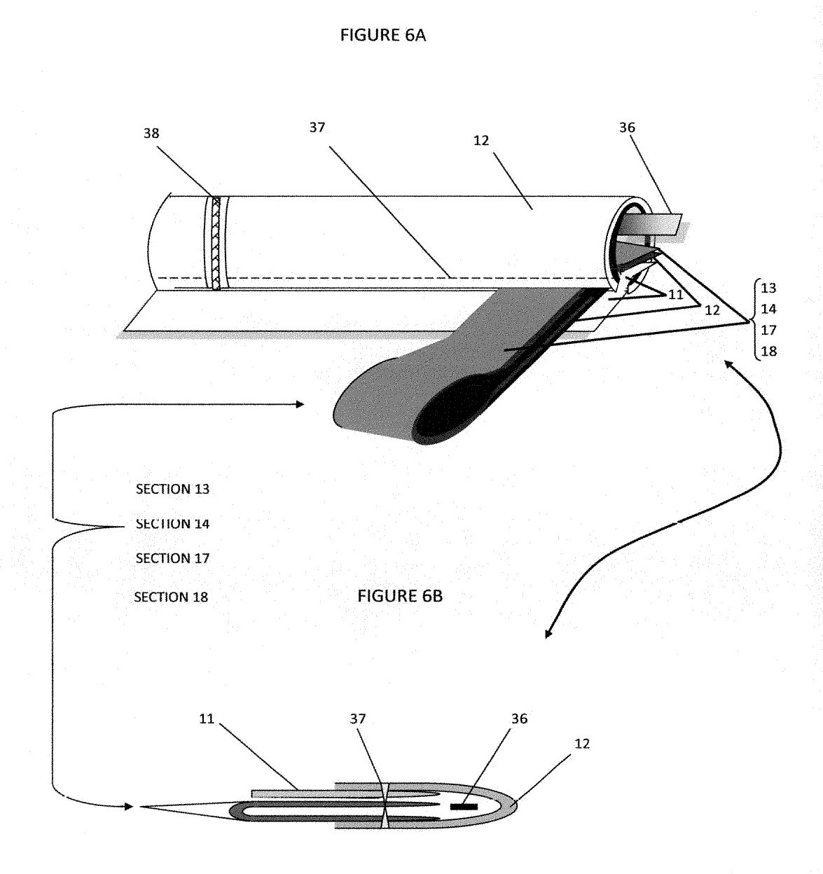

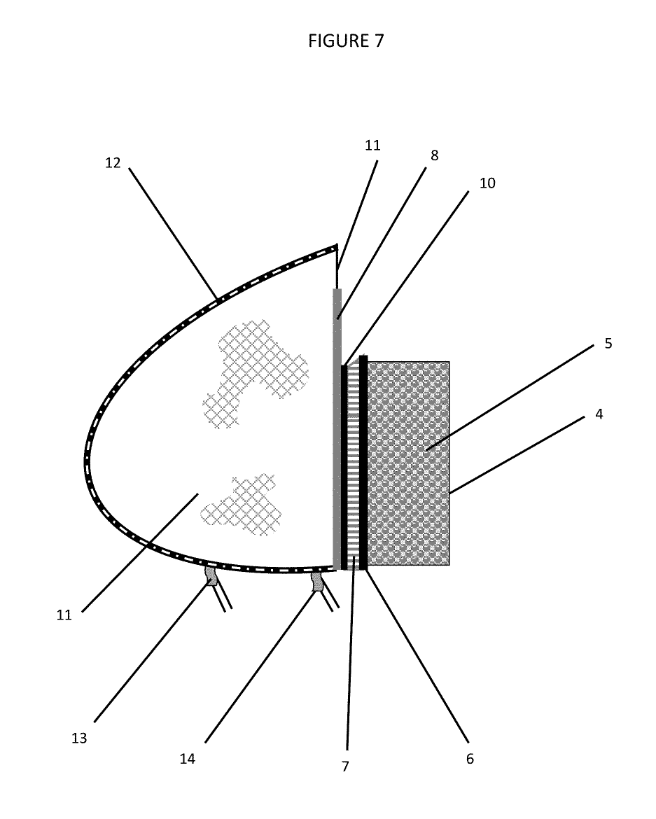

FIG. 1 illustrates a coiling design according to embodiment of the invention. The FIG. 1 design has two separate panels 11 and 3 that are coupled together to form an enclosed space with an opening in the center 19. One panel 11 may be a base panel that is adapted to have one side resting on a ground or semi soft surface, and the other panel 3 may be a center most panel that spans the centermost portion and includes and opening 19 with outside borders coupled with panel 11. The panel 11 is an oblong oval configuration with the longest portions of the panel 11 being the top and bottom edges. The panel 3 is an oval/egg shaped configuration having the wider portion of the panel 3 at the inferior edge of it's perimeter and is coupled together with panel 11. This is best illustrated in FIGS. 1A and 1B.

The outside end edge 11a of the panel 11 is encased by a membrane piece sleeve 12 that extends beyond the periphery of the panel 11. The membrane piece 11 can be stitched 37 between the edges 12a and 12b of the sleeve 12.

Panel 11 has a continuous frame retaining sleeve 12 provided along and traversing the edge of its side. A continuous frame member 36 is retained or held within the frame retaining sleeve 12 to support the panel 11, as shown in FIG. 1.

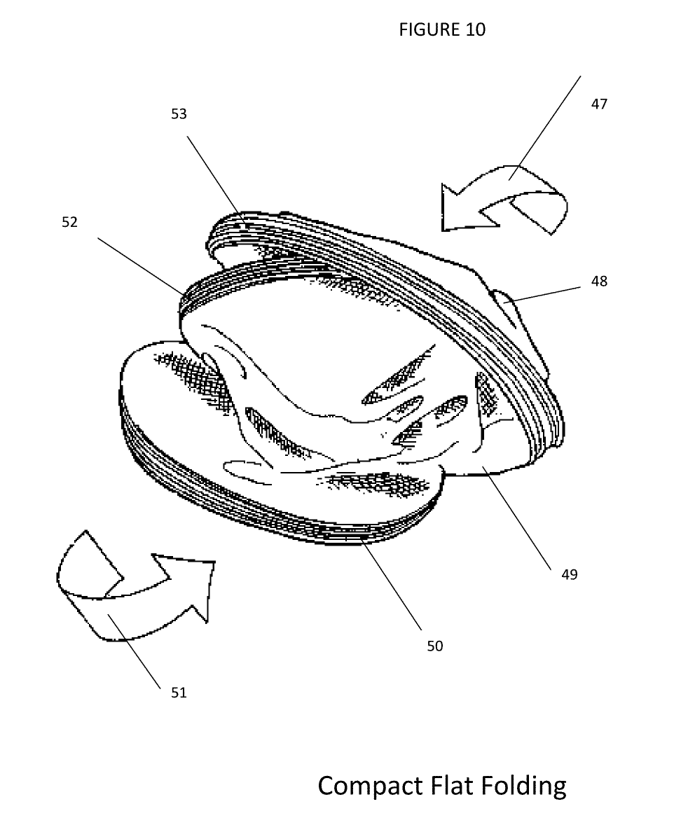

The continuous frame member 2A 2B and 2C of each panel 11, 3 and 7 may be provided as one continuous loop, or may be a strip of material connected at both ends 22, 31 and 38 to form a continuous loop. The frame members 2A 2B and 2C are preferably formed of flexible coilable steel, although other materials such as plastics may also be used. The frame members 2A 2B and 2C should be made of a material which is relatively strong and yet is flexible to a sufficient degree to allow it to be coiled. Relative to the size of frame member 2A, it is capable of assuming two positions, an open or expanded position such as shown in FIG. 1, or a coiled position in which the frame member is coiled into a size which is greatly reduced from its open position FIG. 10. The material should have a memory that allows frame member 2A to spring back to the expanded position when uncoiled from the coiled position. Frame member 2A forms the outside perimeter of the invention. The frame retaining sleeve 12 may be mechanically fastened, stitched, fused, or glued to its frame member 2A to retain it in position.

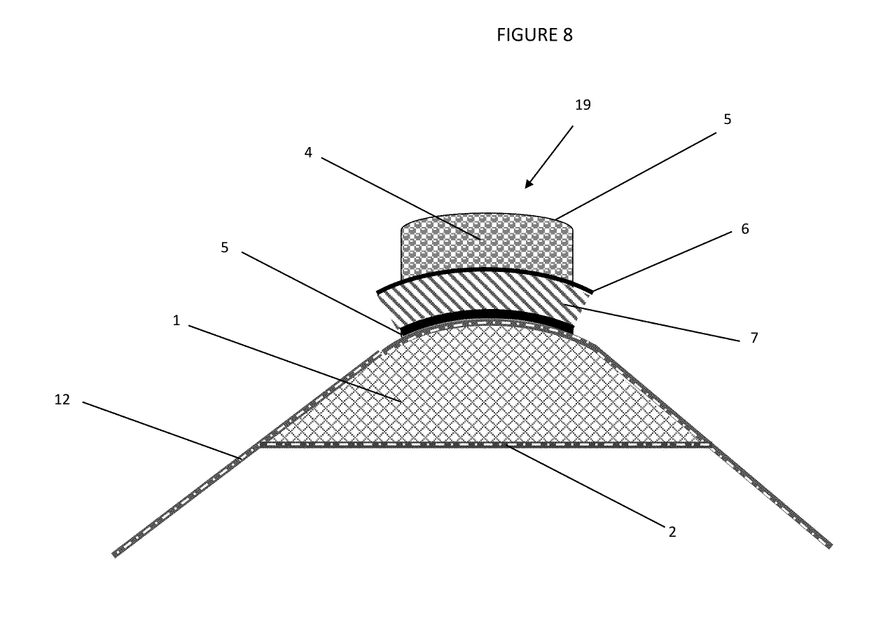

Membrane or sheet material extends across panel 11, and is held taut when panel 11 is in its open position. The term membrane is to be given its broadest meaning and should be made from strong, lightweight materials preferably mesh materials but could include woven membranes, sheet membranes or even films. All illustrations of the invention FIG. 1 though FIG. 8 with the exclusion of membranes 13, 14, 17, 18, 12, 2, 8, 10, 6, and 16 should be of meshed material to accomplish the aerodynamic design of the invention. All membranes incorporated should be water, mold and mildew proof/resistant and durable to withstand the wear and tear associated with rugged outdoor use.

As illustrated in FIGS. 1C and 1D, the frame retaining sleeve 2 can be attached to the panel 1 along the top hood edge of the panel 11. Specifically, the panel 1 can be attached to the frame retaining sleeve 2 by stitching 25a and 25b that extends along the front edge of panel 1. Panel 1 extends equally beyond and with the periphery of panel 11. The stitching 25 can also operate to enclose the frame member 26 within frame retaining sleeve 2. Alternatively, the frame retaining sleeve 2 can be a part of or an extension of the panel 1, where the side edge of the panel 1 can be wrapped around the frame member 26 to enclose the frame member 26, and then the stitching 27 applied to enclose the sleeve 2. Distal portion of panel 1 extends equally beyond and with the curved periphery of panel 11.

FIGS. 1E and 1F illustrates a design that is essentially the same as the design in FIGS. 1C and 1D, except that the front frame retaining edge 16 and the bottom base panel 15 is considerably more narrow than the top hood panel 1 and can be attached directly (such as by stitching) to the center most edge of panel 11 and frame retaining sleeve 12. Thus, the bottom base panel 15 extends across panel 11, and is held taut when panel 11 is in its open fully position. Specifically, the membrane 15 can be attached to the frame retaining sleeve 16 by stitching 20a and 20b that extends along the front edge of panel 15. Distal portion of panel 15 extends equally beyond and with the curved periphery of panel 11. The stitching 20 can also operate to enclose the frame member 21 within frame retaining sleeve 2. Alternatively, the frame retaining sleeve 16 can be a part of or an extension of the panel 15, where the side edge of the panel 15 can be wrapped around the frame member 21 to enclose the frame member 21, and then the stitching 20 applied to enclose the sleeve 16.

The frame member 1C 1D and 1E 1F of each of panels 15 and 1 may be a strip of material within the frame retaining sleeve extending end to end of each of 2 and 16. Frame members 21 and 26 are preferably formed of flexible coilable commercial grade plastic, although other materials such as steel may also be used. The frame members 21 and 26 should be made of a material which is relatively strong and yet is flexible to a sufficient degree to allow it to bend. Frame members 21 and 26 do not coil in the invention by design, but are flexible in all positions including the coiled position in which the frame member 12 is coiled into a size which is greatly reduced from its open position FIG. 10. The material should have a memory yet strength and rigidity enough that allows frame members 21 and 26 to be supportive of the bottom base 1E and 1F and top hood 1C and 1D, respectively, when invention FIG. 1 is in the fully expanded open position. Frame member 21 in frame retaining sleeve 16 forms the front perimeter of the top hood and serves as the mechanism which partially encloses the upper portion of the invention in the fully expanded and open configuration. Frame member 26 in frame retaining sleeve 2 forms the front perimeter of the bottom base and serves as the mechanism which shapes the invention in the fully expanded and open configuration. The frame retaining sleeves 16 and 2 may be mechanically fastened, stitched, fused, or glued, respectively, to the frame members 21 and 26 to retain it in position.

The flexible and coilable nature of frame member 2A allows the front panel 11 to be flexed so that its side edge 12 can be positioned adjacent to the other top, bottom and side edges of 12 and joined to the inner panel 3. The oval/egg shape center panel 3 functions to support/hold the front panel 11 in its upright, extended and fully uncoiled configuration. Panel 3 extends beyond and with the periphery of panel 11. The panel 11 has a defining opening 19 that can be attached to panel 3 with a membrane sleeve 10.

As demonstrated in FIGS. 1G and 1H, the interior most membrane 5 coils to comprise a distal coiled edge 4 and two proximal open edges 5a and 5b. The membrane sleeve 10 forms a defined opening 19 within the interior perimeter 10 of panel 3 and the interior surface of panel 5 and can be stitched or otherwise connected to the layered membrane pieces 7, 5a and 5b. The panel 3 has end exterior edges that are stitched to the membrane of the front panel 11. A membrane retaining sleeve 12 is provided along a first exterior edge of the panel 3 and extends along the end edges of panel 11. The center opening portion of panel 3 is formed by a membrane retaining sleeve. The first membrane edge is proximal 5a and between the edge of the proximal panel 5b and the edge of the proximal panel 3 is the edge of proximal panel 7. The membranes are attached and retained within the membrane retaining sleeve 10. Similarly, a frame retaining sleeve 6 is provided along the edge of the distal panel 7. Frame retaining sleeve 10 extends along the end proximal edges of panels 7, 5a and 5b and along the complete portion of the inner edge of membrane piece panel 3. Thus, the sleeve 10 defines the inner periphery of the panel 3. A portion of the sleeves 12, 6 and 8 adjacent their respective panels 11, 7 and 12/3 can be interrupted (or an opening defined) so that the frame members 36, 29 and 33 are exposed thereat. The sleeves 12, 6 and 8 can be formed in the manner explained in connection with FIGS. 1A and 1B, 1G and 1H, 1I and 1J and may be stitched to their respective panels 11, distal 7 and proximal 11/distal 3.

The diameter of the front oval/egg shaped panel 3 opening formed by membrane sleeve 10 is smaller than the diameter of the opening created by panel 7 and frame retaining sleeve 6. The frame retaining sleeve 6 serves as the basis for attachment to the disposable unit separately supplied and attached non-permanently between membrane retaining sleeve 10 and frame retaining sleeve 6 illustrating a loop membrane retained within a draw sleeve closure at opening of disposable unit which ultimately accomplishes reduction of opening of disposable unit utilizing outward force on loop membrane within the sleeve and security of loop membrane within the sleeve to frame retaining sleeve 6 utilizing unit 9.

The flexible and coilable nature of the frame member 2B allows the bottom base panel 15 and the top hood panel 1 to be flexed so that its side edge 12 can be positioned adjacent to it's other top, bottom and side edges to the inner panel 3. Membrane or sheet material extends across panel 3, and is held taut when panel 11 is in its open position. The oval/egg shape center panel 3 functions to support/hold the front panel 11 in its upright, extended and fully uncoiled configuration. The membrane piece panel 12 extends beyond the periphery of panel 11. The panel 11 has a defining opening 19 that can be attached to panel 3 with a membrane retaining sleeve 10.

Panels 11 and 3 can be larger to allow a wider or taller version of invention. Subsequent panels 1 and 15 can be increased in size proportionate to utilization of the larger panels 11 and 3. Membrane retaining sleeve 10 and panel 5 may be enlarged and frame retaining sleeve 6 may be proportionately sized for other utilization applications. Such a design can be beneficial in applications where the front panel 11 bottom base 15 and top hood 1 is desired to be larger than the same panels/sleeves of current invention, such as but not limited to use where the design is to be used in home or commercial utilization applications. Examples might be accommodation of a plurality of surfaces and conditional applications. It may be desirable to provide users with additional devices to secure invention to multiple surfaces when placed on a rough ground or surface. Options may include but not be limited to suction plastic metal magnetic or wood. A plurality of membranes and or frame members and retaining sleeves and concepts can be utilized to achieve a variety of outcomes for the applications of the invention, currently and/or revised versions.

The panel 1 has end edges that are stitched to the panel 11 within the frame retaining sleeve 12 provided along an outer edge of the panel 1 and extends along the outer edge of panel 11 and is medially centered thereof. The front proximal edge of panel 1 is stitched within the frame retaining sleeve 2 provided along the distal front edge of the panel 1. Thus, the sleeve 2 defines the front periphery of the panel 1. A portion of the sleeve 2 adjacent to panel 1 can be interrupted (or an opening defined) so that the frame member 26 is exposed thereat. The sleeve 2 can be formed in the manner explained in connection with FIGS. 1C and 1D and may be stitched to front proximal membrane panel 1.

The panel 15 has end edges that are stitched to the panel 11 within the frame retaining sleeve 16 provided along an outer edge of the panel 15 and extends along the outer edge of membrane panel 11 and is medially centered thereof. The front proximal edge of panel 15 is stitched within the frame retaining sleeve 16 provided along the distal front edge of the panel 15. Thus, the sleeve 16 defines the front periphery of the panel 15. A portion of the sleeve 16 adjacent to panel 15 can be interrupted (or an opening defined) so that the frame member 21 is exposed thereat. The sleeve 16 can be formed in the manner explained in connection with FIGS. 1E and 1F and may be stitched to front proximal membrane panel 15.

To assemble the unit in FIG. 1, the membrane panel 11 is cut to its desired shape and then formed with its sleeve 12, such as by stitching the sleeve 12 to the panel 11. Thereafter, one frame member 36 is provided in the form of a strip of coilable material, and one end of the frame member 36 is inserted through the sleeve 12 via the opening at either of the end of the outer edge of panel 11. When the entire frame member 36 extends throughout the lumen of the sleeve 12, the ends of the frame member 12 are connected. Then, the membrane panel 3 is cut to its desired shape and then formed with its sleeve 8, such as by stitching the sleeve 8 to the membrane panel 3. Thereafter, one frame member 33 is provided in the form of a strip of coilable material, and one end of the frame member 33 is inserted through the sleeve 8 via the opening at either of the end of the outer edge of membrane panel 3. When the entire frame member 33 extends throughout the lumen of the sleeve 8, the ends of the frame member 33 are connected. Then, membrane panel 7 is cut to its desired shape the side end edges of membrane panel 7 are joined and stitched for complete encompassing closure to form a cylindrical design. Membrane panel 7 is then formed with its sleeve 6, such as by stitching the sleeve 6 to the distal end edge membrane of panel 7. Thereafter, one frame member 29 is provided in the form of a strip of coilable material, and one end of the frame member 29 is inserted through the sleeve 6 via the opening at either of the end of the outer edge of membrane panel 7. When the entire frame member 29 extends throughout the lumen of the sleeve 6, the ends of the frame member 29 are connected. Then, the membrane panel 15 is cut to its desired shape and then formed with its sleeve 16, such as by stitching the sleeve 16 to the panel 15. Thereafter, one frame member 29 is provided in the form of a strip of coilable material, and one end of the frame member 29 is inserted through the sleeve 16 via the opening at either of the end of the outer edge of panel 1. When the entire frame member extends throughout the lumen of the sleeve 16, the and right and left ends terminate at the point of connection by stitching to panel 15 and the frame retaining sleeve 16. Then, the membrane panel 1 is cut to its desired shape and then formed with its sleeve 2, such as by stitching the sleeve 25 to the panel 1. Thereafter, one frame member 26 is provided in the form of a strip of coilable material, and one end of the frame member 26 is inserted through the sleeve 2 via the opening at either of the end of the outer edge of panel 1. When the entire frame member extends throughout the lumen of the sleeve 2, the and right and left ends terminate at the point of connection by stitching to panel 1 and the frame retaining sleeve 2.

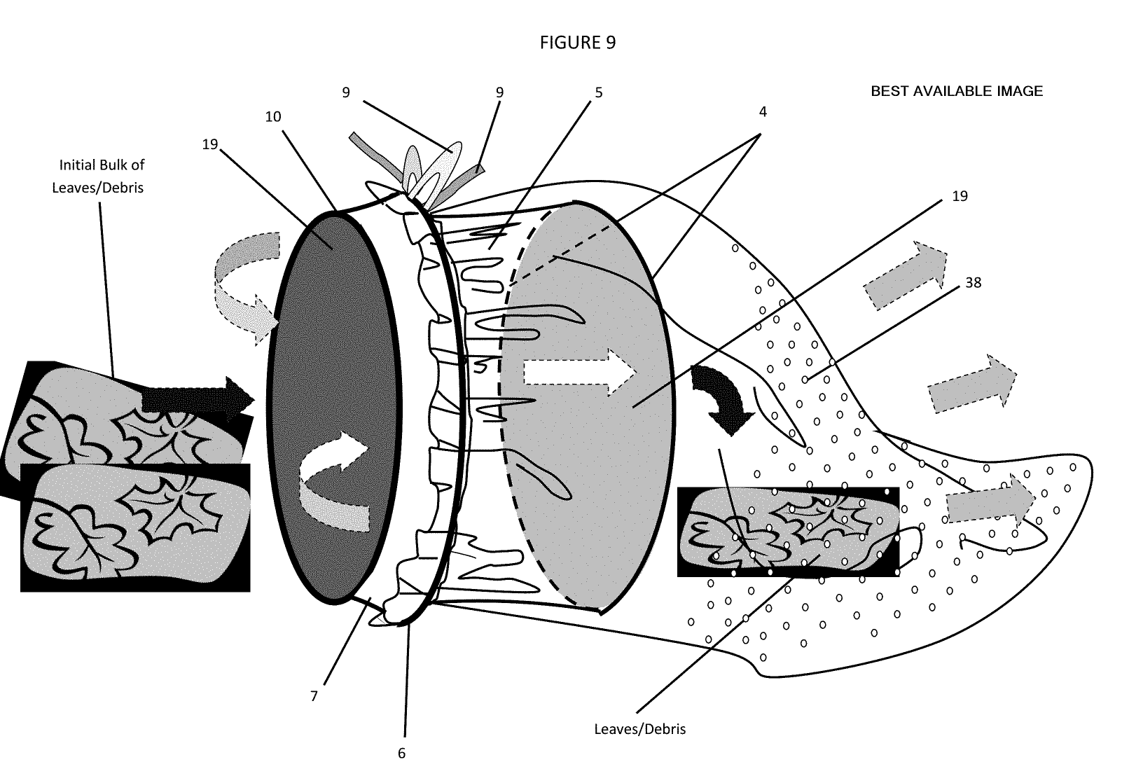

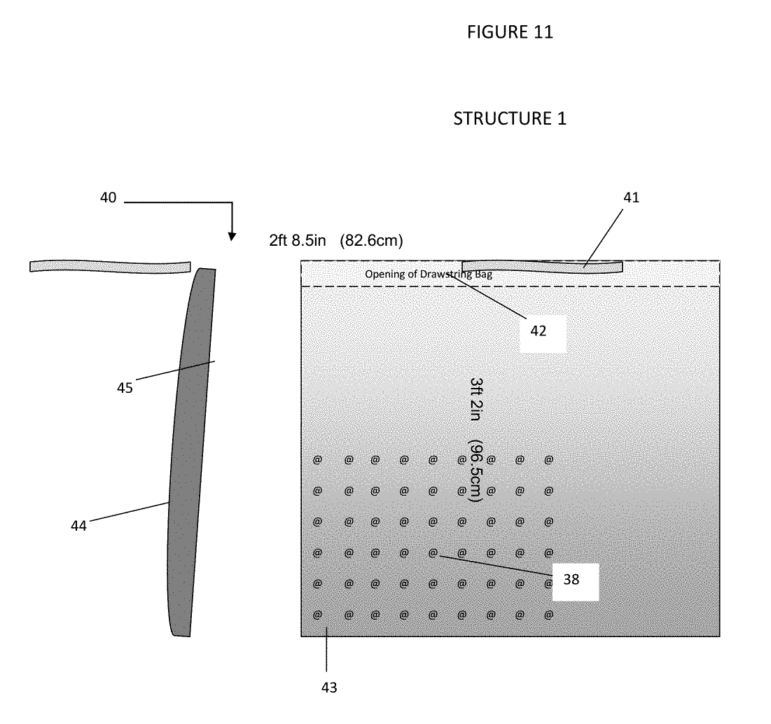

FIGS. 9-11 illustrate how the design in FIG. 1 can be coiled and reduced into a compact configuration for storage. First, place unit in FIG. 1 flat on the ground or floor surface. Then place one foot on the outside edge of the lower portion of the frame retaining sleeve 12, thereby also partially covering the bottom edge of interior frame retaining sleeve edge 8. The opposing right and left sides of the unit in FIG. 1 (e.g., adjacent the side edges of FIG. 1, bilaterally 12) are flexed or twisted down and inwardly in the direction of the arrows as shown in FIG. 10, while placing each side towards each other, overlapping one side over the other and holding in place at the front of the base. The left and right sides of the unit in FIG. 1 are now folded one on top of the other, as shown in FIGS. 10, 53, 52 and 50. This forms a combination of stacked panels 53, 52 and 50 that are twisted and coiled, see opposing arrows 47 and 51 to coil the panel 12. The coiling is continued so that the initial size of the unit in FIG. 1 is reduced until the left and right sides of the panel 12 are coiled on each other to provide for a smaller more compact configuration having a plurality of concentric frame members and layers of the membranes so that the coiled unit in FIG. 1 has a size which is a fraction of the size of the initial design in FIG. 1, as shown in FIG. 10. The panel 3 and frame retaining sleeves on panels 5, 74 are already somewhat aligned, or one on top of the other, which makes the first step of FIG. 10 easy to carry out. Thus, the configurations of the units of the present invention may be easier and may require less time to coil and flatten when compared to other known coiling designs.

To re-open the unit in FIG. 1 to its expanded configuration, the flattened panel 12 is uncoiled. The frame members 8 and 6 remain open thereby eliminating the need to open them. The opening of the design in FIG. 1, frame retaining sleeve, will cause the frame member to uncoil on its own and to quickly expand the panel 11 to the expanded configuration shown in FIG. 1.

Providing frame member 8 to support the panel 11 allows a wider and higher panel 11 to be provided, thereby rendering the design in FIG. 1 well-suited for use with powered lawn debris and leaf blowing devices or other applications where a unit defining a large for collecting debris is desired. As shown in FIG. 1, the peripheral or outer frame member 11 spans a larger elongated area, with the inner frame member 8 providing the necessary support to the panel 11 and frame retaining sleeve 12 in addition to the center assembly including the membrane retaining sleeve 10, collar membrane panel 7 with attached frame retaining sleeve 6 and panel 5, 5a and 5b. Without the support of the inner frame retaining sleeve 8, the outer frame member 12 would be too flimsy to support a panel 11 having such a large width and height.

The units illustrated herein are examples of simple designs that can be provided according to the present invention. However, designs having a different and more complex configuration can also be provided according to the principles of the present invention. For example, as it pertains to a more aggressive commercial product, a much larger version of the invention can be designed. It is possible to provide a plurality of membrane pieces, modifications to design and utilization and types of frame and membranes may be provided to accommodate the revision of the current invention.

As another non-limiting example, while the front and center panels of the unit according to the present invention are shown and described as being a particular size and configuration, it is possible for panels to have adjusted configuration to accommodate additional or different utilization. It is also possible to provide the panels of a given unit with additional numbers of panels (e.g., a different shape, membrane, size, or number of panels). Thus, the units according to the present invention may be provided in a variety of configurations in which the number of panels and the shape and size of the panels may be varied. The principles of the present invention can be employed to provide support and stability at certain desired locations to vary the shapes and sizes of the resulting units.

The designs according to the present invention can be easily deployed and disassembled, and are easy to coil and flatten into a compact configuration for convenient storage or transportation in its own storage bag for containment.

While the description above refers to particular embodiments of the present invention, it will be understood that many modifications may be made without departing from the spirit thereof. The accompanying claims are intended to cover such modifications as would fall within the true scope and spirit of the present invention.

1. A coilable leaf bagging device generally oval/egg shaped in configuration with rear attachment of disposable specifically designed perforated receptacle intended for use in bagging leaves utilizing the aerodynamics of a power operated leaf/lawn debris power blower and having 6 membranes and 3 flexible loop members having memory within sleeves to form a plurality of concentric loop rings and layers of aerodynamically constructed membrane to substantially reduce the size of the structure and able to be supported on a penetrable firm surface comprising:

2. Multiple frame members, 1 having a coilable flattened and an uncoiled orientation;

3. A membrane covering a portion of 1 frame member attached to the aerodynamic membrane to form the outermost panel when the frame member is in the uncoiled orientation;

4. A membrane covering a portion of 1 frame member to form a longitudinal support panel for 2 of the frame members when the frame member is in the uncoiled orientation;

5. A membrane covering a portion of 1 frame member to form a rim on the distal portion of the aerodynamic membrane;

6. Whereas 2 panels having a generally oval/egg shaped orientation;

7. The coilable leaf bagging device of claim 6, wherein the coilable leaf bagging device comprises 2 panels and frame members, each panel and its frame generally oval/egg shaped in configuration.

8. The coilable leaf bagging device of claim 5, wherein the membrane covering a portion of 1 frame member to form a rim on the distal portion of the aerodynamic membrane comprises a hood aerodynamic membrane attaching to top edge of the first outer most aerodynamic membrane.

9. The coilable leaf bagging device of claim 5, wherein the membrane covering a portion of 1 frame member to form a rim on the distal portion of the aerodynamic membrane comprises a base aerodynamic membrane attaching to bottom edge of the first outer most aerodynamic membrane.

10. The coilable leaf bagging device of claim 7, further comprising a central generally oval/egg shaped smaller opening provided within the aerodynamic membrane of the front outermost generally oval/egg shaped larger panel and connected to the frame retaining sleeve of a generally circular central second smaller opening.

11. The coilable leaf bagging device of claim 10, wherein one generally smaller oval/egg shaped panel comprises a generally circular opening.

12. The coilable leaf bagging device of claim 11, wherein circular opening in generally oval/egg shaped panel attaches jointly to 1 single aerodynamic membrane and 1 double aerodynamic membrane.

13. The coilable leaf bagging device of claim 12, wherein single aerodynamic membrane attached to opening of generally oval/egg shaped panel aerodynamic membrane attaches to third frame retaining sleeve.

14. The coilable leaf bagging device of claim 1, wherein each panel comprises a frame retaining sleeve for holding the frame members, the frame retaining sleeve of one panel attached to aerodynamic membrane converging to form a singular retaining sleeve which retains the adjacent sides of the adjacent frame members of the corresponding adjacent panels.

15. The coilable leaf bagging device of claim 1, The hood aerodynamic membrane attaches to top edge of the first aerodynamic membrane.

16. The coilable leaf bagging device of claim 1, further comprising the employment of the rear attachment of disposable specifically designed perforated receptacle intended for use in bagging leaves through means of egress utilizing the third generally circular frame retaining sleeve for retention of receptacle accomplishes same.

17. The coilable leaf bagging device of claim 1, wherein device design is intended for use on and able to be supported within a penetrable firm surface such as ground, faux turf products, ground supported gravel, ground supported rubber pellets or otherwise soft product, ground mulch/bark, or other soft or firm excluding rigid/solid un penetrable surfaces.
